(19) United States
(12) Patent Application Publication
(10) Pub. No.: US 2023/0265605 A1
(43) Pub. Date: Aug. 24, 2023

(54) METHOD FOR TREATING A FABRIC IN A DRYER IN PRESENCE OF MICROORGANISMS

(71) Applicant: The Procter & Gamble Company, Cincinnati, OH (US)

(72) Inventors: Samuel Kimani NJOROGE, Montgomery, OH (US); Neil Joseph LANT, Newcastle upon Tyne (GB); Destiny Marie POWERS, Cincinnati, OH (US); Todd Michael WERNICKE, Cincinnati, OH (US)

(21) Appl. No.: 18/310,875

(22) Filed: May 2, 2023

Related U.S. Application Data
(63) Continuation of application No. PCT/US2022/017250, filed on Feb. 22, 2022.

(30) Foreign Application Priority Data
Feb. 25, 2021 (EP) 21159285.2

(51) Int. Cl. D06M 16/00; D06F 60/00

(52) U.S. Cl. CPC D06M 16/003; D06F 60/00; D06M 2200/50

(57) ABSTRACT

A method of treating a fabric in a dryer, the method including placing the fabric in the dryer and delivering at least 1×10² CFU of cleaning microorganisms into the dryer.

### FIELD OF THE INVENTION

The present invention is in the field of fabric care. In particular the invention relates to a method to provide fabric benefits in a dryer. More in particular, the method involves treating a fabric with cleaning microorganisms. The invention also relates to a solid carrier comprising cleaning microorganisms to control fabric malodor.

### BACKGROUND OF THE INVENTION

Malodor on fabrics even after they have been washed seems to be a recurring problem. Malodor can be the result of having wet clothes for an extended period of time, it can be the result of sweat generated by the user, it can be the result of fabrics picking malodor from the surrounding environment or it can be a combination thereof.

The objective of the present invention is to control malodors on fabrics, including a sustained malodor control during fabric use.

### SUMMARY OF THE INVENTION

According to the first aspect of the invention, there is provided a method of treating a fabric in a dryer. The method comprises the steps of:
a) placing the fabric in the dryer; and
b) delivering an effective amount of cleaning microorganisms to the fabric.
Preferably, the cleaning microorganisms comprise bacteria, more preferably bacterial spores, more preferably Bacillaceae spores and especially Bacillus spores.

According to the second aspect of the invention, there is provided a dryer sheet comprising cleaning microorganisms, preferably bacterial spores, more preferably Bacillaceae spores and most preferably Bacillus spores. There is also provided a process for making a dryer sheet comprising cleaning microorganisms, preferably bacterial spores, more preferably Bacillaceae spores and most preferably Bacillus spores.

According to a further aspect of the invention, there is provided the use of a solid carrier comprising cleaning microorganisms, preferably bacterial spores, more preferably Bacillaceae spores and most preferably Bacillus spores, in a dryer to provide fabric malodor control during fabric.

The elements of the method of the invention described in relation to the first aspect of the invention apply mutatis mutandis to the other aspects of the invention.

### DETAILED DESCRIPTION OF THE INVENTION

The present invention encompasses a method of treating a fabric in a dryer. The method requires the separate addition of an effective amount of cleaning microorganisms to the dryer. Although microorganisms can be present in dryers and on fabrics, the method of the invention involves the intentional addition of cleaning microorganisms to the dryer in an amount capable of providing a consumer noticeable fabric benefit. The method of the invention requires the intentional addition to the dryer of at least 1×10² CFU, preferably at least 1×10³ CFU, preferably at least 1×10⁴ CFU, preferably at least 1×10⁵ CFU and preferably less than 1×10¹² CFU. By “intentional addition of cleaning microorganisms” is herein meant that the microorganisms are added in addition to the microorganisms that might be present in the dryer or might be carried on the fabrics.

“Cleaning microorganisms” is herein understood to be living microbes capable of degrading substances associated with dirt, food residues, grease and other objectionable matter (known in cleaning terminology as ‘soil’). The “cleaning microorganisms” of the method of the invention are sometimes referred to as “the microorganism of the invention”. The microorganisms of the invention are not deactivated by heat at the temperatures found in a dryer. The microorganisms are fabric-substantive and provide malodor control during and after the drying process, in particular during and after the use (e.g. wearing) of the fabrics. Another example can be found on towels. Towels can acquire malodor after being used and left in the humid environment of a bathroom. The microorganisms of the invention provide continuous malodor control.

Without being bound by theory, it is believed that the microorganisms of the invention control laundry malodors by one or both of the following mechanisms:
1. Catalyzing the breakdown of soils through release of enzymes, metal chelating agents and biosurfactants during and after the use of the fabrics leading to reduced generation of malodors.
2. Direct metabolism of malodor species such as amines and thiols by the cleaning microorganisms, e.g. involving enzymes such as oxidoreductases, leading to reduced concentrations of these malodors being released into the headspace.

The microorganisms of the method of the invention can germinate on the fabrics. The microorganisms can be activated by the heat provided in the dryer and germinate when the fabrics are stored and/or used. Malodor precursors can be used by the microorganisms as nutrients promoting germination.

The fabric to be treated in the dryer can be wet or humid or it can be dry. It can be treated wet after being washed. Although the washing process reduces the amount of microorganisms and metabolite on the fabrics further bacteria from the washing machine and washing water can be transferred to the fabrics. Alternatively, the fabric can be treated dry in order to refresh it.

All percentages, ratios and proportions used herein are by weight percent of the composition, unless otherwise specified. All average values are calculated “by weight” of the composition, unless otherwise expressly indicated. All ratios are calculated as a weight/weight level, unless otherwise specified.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

As used herein, the term “fabric” is intended to include any object, article or item made from or containing at least in part some woven or non-woven fabric portion that may be treated in an automatic dryer cycle.

### METHOD OF THE INVENTION

The method of the invention involves the treatment of a fabric in a dryer to provide malodor reduction benefits. The dryer for use in the method of the invention includes any type of dryer that uses heat and agitation or heat and airflow to remove water from fabrics. An exemplary dryer that can be used includes a tumble-type dryer where the fabrics are provided within a rotating drum that causes the fabrics to tumble during the operation of the dryer. Tumble-type dryers are commonly found in residences and in commercial and industrial laundry operations. The method of the invention preferably takes place in a tumble dryer. The fabric is placed in the drum of the dryer. As mentioned herein before, the fabric can be wet, damp or dry. The drying cycle is initiated in the dryer. Usually the fabric is subject to a temperature in the range of from about 40° C. to about 100° C. The duration of the drying process is determined as function of the wetness of the fabric. During the drying the fabric is exposed to at least 1×10² CFU, preferably at least 1×10³ CFU, preferably at least 1×10⁴ CFU of cleaning microorganisms and preferably less than 1×10¹² CFU of cleaning microorganisms.

### Cleaning Microorganisms

The cleaning microorganisms for use herein: i) are viable microorganisms capable of surviving the temperatures found in the dryer; ii) are fabric substantive; iii) have the ability to control odor; and iv) preferably have the ability to support the cleaning action of laundry detergents. The cleaning microorganisms can be in vegetative state but preferably are in the form of spores and have the ability to start to germinate and to form cells in the dryer and continue to germinate and form cells on the fabrics using malodor precursors as nutrients. The microorganisms can be delivered into the dryer in liquid or solid form. Preferably, the microorganisms are in solid form. The microorganisms can be delivered to the drying process from a reservoir, a dryer ball, a solid carrier, such as a pouch, pellets, a tablet, a dryer sheet, etc. Preferably the pellets are substantially spherical and/or cylindrical and have a diameter of from about 1 mm to about 30 mm. Preferably the microorganisms are delivered from a dryer sheet.

### Bacterial Spores

Some gram-positive bacteria have a two-stage lifecycle in which growing bacteria under certain conditions such as in response to nutritional deprivation can undergo an elaborate developmental program leading to spores or endospores formation. The bacterial spores are protected by a coat consisting of about 60 different proteins assembled as a biochemically complex structure with intriguing morphological and mechanical properties. The protein coat is considered a static structure that provides rigidity and mainly acting as a sieve to exclude exogenous large toxic molecules, such as lytic enzymes. Spores play critical roles in long term survival of the species because they are highly resistant to extreme environmental conditions. Spores are also capable of remaining metabolically dormant for years. Methods for obtaining bacterial spores from vegetative cells are well known in the field. In some examples, vegetative bacterial cells are grown in liquid medium. Beginning in the late logarithmic growth phase or early stationary growth phase, the bacteria may begin to sporulate. When the bacteria have finished sporulating, the spores may be obtained from the medium, by using centrifugation for example. Various methods may be used to kill or remove any remaining vegetative cells. Various methods may be used to purify the spores from cellular debris and/or other materials or substances. Bacterial spores may be differentiated from vegetative cells using a variety of techniques, like phase-contrast microscopy, automated scanning microscopy, high resolution atomic force microscopy or tolerance to heat, for example.

Because bacterial spores are generally environmentally-tolerant structures that are metabolically inert or dormant, they are readily chosen to be used in commercial microbial products. Despite their ruggedness and extreme longevity, spores can rapidly respond to the presence of small specific molecules known as germinants that signal favorable conditions for breaking dormancy through germination, an initial step in the process of completing the lifecycle by returning to vegetative bacteria. For example, the commercial microbial products may be designed to be dispersed into an environment where the spores encounter the germinants present in the environment to germinate into vegetative cells and perform an intended function. A variety of different bacteria may form spores. Bacteria from any of these groups may be used in the compositions, methods, and kits disclosed herein. For example, some bacteria of the following genera may form spores: Acetonema, Alkalibacillus, Ammoniphilus, Amphibacillus, Anaerobacter, Anaerospora, Aneurinibacillus, Anoxybacillus, Bacillus, Brevibacillus, Caldanaerobacter, Caloramator, Caminicella, Cerasibacillus, Clostridium, Clostridiisalibacter, Cohnella, Dendrosporobacter, Desulfotomaculum, Desulfosporomusa, Desulfosporosinus, Desulfovirgula, Desulfunispora, Desulfurispora, Filifactor, Filobacillus, Gelria, Geobacillus, Geosporobacter, Gracilibacillus, Halonatronum, Heliobacterium, Heliophilum, Laceyella, Lentibacillus, Lysinibacillus, Mahella, Metabacterium, Moorella, Natroniella, Oceanobacillus, Orenia, Ornithinibacillus, Oxalophagus, Oxobacter, Paenibacillus, Paraliobacillus, Pelospora, Pelotomaculum, Piscibacillus, Planifilum, Pontibacillus, Propionispora, Salinibacillus, Salsuginibacillus, Seinonella, Shimazuella, Sporacetigenium, Sporoanaerobacter, Sporobacter, Sporobacterium, Sporohalobacter, Sporolactobacillus, Sporomusa, Sporosarcina, Sporotalea, Sporotomaculum, Syntrophomonas, Syntrophospora, Tenuibacillus, Tepidibacter, Terribacillus, Thalassobacillus, Thermoacetogenium, Thermoactinomyces, Thermoalkalibacillus, Thermoanaerobacter, Thermoanaeromonas, Thermobacillus, Thermoflavimicrobium, Thermovenabulum, Tuberibacillus, Virgibacillus, and/ or Vulcanobacillus.

Preferably, the bacteria that may form spores are from the family Bacillaceae, such as species of the genera Aeribacillus, Aliibacillus, Alkalibacillus, Alkalicoccus, Alkalihalobacillus, Alkalilactibacillus, Allobacillus, Alteribacillus, Alteribacter,Amphibacillus, Anaerobacillus,Anoxybacillus,Aquibacillus, Aquisalibacillus, Aureibacillus, Bacillus, Caldalkalibacillus, Caldibacillus, Calditerricola, Calidifontibacillus, Camelliibacillus, Cerasibacillus, Compostibacillus, Cytobacillus, Desertibacillus, Domibacillus, Ectobacillus, Evansella, Falsibacillus, Ferdinandcohnia, Fermentibacillus, Fictibacillus, Filobacillus, Geobacillus, Geomicrobium, Gottfriedia, Gracilibacillus, Halalkalibacillus, Halobacillus, Halolactibacillus, Heyndrickxia, Hydrogenibacillus, Lederbergia, Lentibacillus, Litchfieldia, Lottiidibacillus, Margalitia, Marinococcus, Melghiribacillus, Mesobacillus, Metabacillus, Microaerobacter, Natribacillus, Natronobacillus, Neobacillus, Niallia, Oceanobacillus, Ornithinibacillus, Parageobacillus, Paraliobacillus, Paralkalibacillus, Paucisalibacillus, Pelagirhabdus, Peribacillus, Piscibacillus, Polygonibacillus, Pontibacillus, Pradoshia, Priestia, Pseudogracilibacillus, Pueribacillus, Radiobacillus, Robertmurraya, Rossellomorea, Saccharococcus, Salibacterium, Salimicrobium, Salinibacillus, Salipaludibacillus, Salirhabdus, Salisediminibacterium, Saliterribacillus, Salsuginibacillus, Sediminibacillus, Siminovitchia, Sinibacillus, Sinobaca, Streptohalobacillus, Sutcliffiella, Swionibacillus, Tenuibacillus, Tepidibacillus, Terribacillus, Terrilactibacillus, Texcoconibacillus, Thalassobacillus, Thalassorhabdus, Thermolongibacillus, Virgibacillus, Viridibacillu, Vulcanibacillus, Weizmannia. In various examples, the bacteria may be strains of Bacillus Bacillus acidicola, Bacillus aeolius, Bacillus aerius, Bacillus aerophilus, Bacillus albus, Bacillus altitudinis, Bacillus alveayuensis, Bacillus amyloliquefaciensex, Bacillus anthracis, Bacillus aquiflavi, Bacillus atrophaeus, Bacillus australimaris, Bacillus badius, Bacillus benzoevorans, Bacillus cabrialesii, Bacillus canaveralius, Bacillus capparidis, Bacillus carboniphilus, Bacillus cereus, Bacillus chungangensis, Bacillus coahuilensis, Bacillus cytotoxicus, Bacillus decisifrondis, Bacillus ectoiniformans, Bacillus enclensis, Bacillus fengqiuensis, Bacillus fungorum, Bacillus glycinifermentans, Bacillus gobiensis, Bacillus halotolerans, Bacillus haynesii, Bacillus horti, Bacillus inaquosorum, Bacillus infantis, Bacillus infernus, Bacillus isabeliae, Bacillus kexueae, Bacillus licheniformis, Bacillus luti, Bacillus manusensis, Bacillus marinisedimentorum, Bacillus mesophilus, Bacillus methanolicus, Bacillus mobilis, Bacillus mojavensis, Bacillus mycoides, Bacillus nakamurai, Bacillus ndiopicus, Bacillus nitratireducens, Bacillus oleivorans, Bacillus pacificus, Bacillus pakistanensis, Bacillus paralicheniformis, Bacillus paramycoides, Bacillus paranthracis, Bacillus pervagus, Bacillus piscicola, Bacillus proteolyticus, Bacillus pseudomycoides, Bacillus pumilus, Bacillus safensis, Bacillus salacetis, Bacillus salinus, Bacillus salitolerans, Bacillus seohaeanensis, Bacillus shivajii, Bacillus siamensis, Bacillus smithii, Bacillus solimangrovi, Bacillus songklensis, Bacillus sonorensis, Bacillus spizizenii, Bacillus spongiae, Bacillus stercoris, Bacillus stratosphericus, Bacillus subtilis, Bacillus swezeyi, Bacillus taeanensis, Bacillus tamaricis, Bacillus tequilensis, Bacillus thermocloacae, Bacillus thermotolerans, Bacillus thuringiensis, Bacillus tianshenii, Bacillus toyonensis, Bacillus tropicus, Bacillus vallismortis, Bacillus velezensis, Bacillus wiedmannii, Bacillus wudalianchiensis, Bacillus xiamenensis, Bacillus xiapuensis, Bacillus zhangzhouensis, or combinations thereof.

In some examples, the bacterial strains that form spores may be strains of Bacillus, including: Bacillus sp. strain SD-6991; Bacillus sp. strain SD-6992; Bacillus sp. strain NRRL B-50606; Bacillus sp. strain NRRL B-50887; Bacillus pumilus strain NRRL B-50016; Bacillus amyloliquefaciens strain NRRL B-50017; Bacillus amyloliquefaciens strain PTA-7792 (previously classified as Bacillus atrophaeus); Bacillus amyloliquefaciens strain PTA-7543 (previously classified as Bacillus atrophaeus); Bacillus amyloliquefaciens strain NRRL B-50018; Bacillus amyloliquefaciens strain PTA-7541; Bacillus amyloliquefaciens strain PTA-7544; Bacillus amyloliquefaciens strain PTA-7545; Bacillus amyloliquefaciens strain PTA-7546; Bacillus subtilis strain PTA-7547; Bacillus amyloliquefaciens strain PTA-7549; Bacillus amyloliquefaciens strain PTA-7793; Bacillus amyloliquefaciens strain PTA-7790; Bacillus amyloliquefaciens strain PTA-7791; Bacillus subtilis strain NRRL B-50136 (also known as DA-33R, ATCC accession No. 55406); Bacillus amyloliquefaciens strain NRRL B-50141; Bacillus amyloliquefaciens strain NRRL B-50399; Bacillus licheniformis strain NRRL B-50014; Bacillus licheniformis strain NRRL B-50015; Bacillus amyloliquefaciens strain NRRL B-50607; Bacillus subtilis strain NRRL B-50147 (also known as 300R); Bacillus amyloliquefaciens strain NRRL B-50150; Bacillus amyloliquefaciens strain NRRL B-50154; Bacillus megateriumPTA-3142; Bacillus amyloliquefaciens strain ATCC accession No. 55405 (also known as 300); Bacillus amyloliquefaciens strain ATCC accession No. 55407 (also known as PMX); Bacillus pumilus NRRL B-50398 (also known as ATCC 700385, PMX-1, and NRRL B-50255); Bacillus cereus ATCC accession No. 700386; Bacillus thuringiensis ATCC accession No. 700387 (all of the above strains are available from Novozymes, Inc., USA); Bacillus amyloliquefaciensFZB24 (e.g., isolates NRRL B-50304 and NRRL B-50349 TAEGRO® from Novozymes), Bacillus subtilis (e.g., isolate NRRL B-21661 in RHAPSODY®, SERENADE® MAX and SERENADE® ASO from Bayer CropScience), Bacillus pumilus (e.g., isolate NRRL B-50349 from Bayer CropScience), Bacillus amyloliquefaciens TrigoCor (also known as “TrigoCor 1448”; e.g., isolate Embrapa Trigo Accession No. 144/88.4Lev, Cornell Accession No.Pma007BR-97, and ATCC accession No. 202152, from Cornell University, USA) and combinations thereof.

In some examples, the bacterial strains that form spores may be strains of Bacillus amyloliquefaciens. For example, the strains may be Bacillus amyloliquefaciens strain PTA-7543 (previously classified as Bacillus atrophaeus), and/or Bacillus amyloliquefaciens strain NRRL B-50154, Bacillus amyloliquefaciens strain PTA-7543 (previously classified as Bacillus atrophaeus), Bacillus amyloliquefaciens strain NRRL B-50154, or from other Bacillus amyloliquefaciens organisms.

In some examples, the bacterial strains that form spores may be Brevibacillus spp., e.g., Brevibacillus brevis; Brevibacillus formosus; Brevibacillus laterosporus; or Brevibacillus parabrevis, or combinations thereof.

In some examples, the bacterial strains that form spores may be Paenibacillus spp., e.g., Paenibacillus alvei; Paenibacillus amylolyticus; Paenibacillus azotofixans; Paenibacillus cookii; Paenibacillus macerans; Paenibacillus polymyxa; Paenibacillus validus, or combinations thereof. The bacterial spores may have an average particle diameter of about 2-50 microns, suitably about 10-45 microns. Bacillus spores are commercially available in blends in aqueous carriers and are insoluble in the aqueous carriers. Other commercially available bacillus spore blends include without limitation Freshen Free™ CAN (10X), available from Novozymes Biologicals, Inc.; Evogen® Renew Plus (10X), available from Genesis Biosciences, Inc.; and Evogen® GT (10X, 20X and 110X), all available from Genesis Biosciences, Inc. In the foregoing list, the parenthetical notations (10X, 20X, and 110X) indicate relative concentrations of the Bacillus spores.

Bacterial spores used in the compositions, methods, and products disclosed herein may or may not be heat activated. In some examples, the bacterial spores are heat activated. In some examples, the bacterial spores are not heat inactivated. Preferably, the spores used herein are heat activated. Heat activation may comprise heating bacterial spores from room temperature (15-25° C.) to optimal temperature of between 25-120° C., preferably between 40° C.-100° C., and held the optimal temperature for not more than 2 hours, preferably between 70-80° C. for 30 min.

For the methods, compositions and products disclosed herein, populations of bacterial spores are generally used. In some examples, a population of bacterial spores may include bacterial spores from a single strain of bacterium. Preferably, a population of bacterial spores may include bacterial spores from 2, 3, 4, 5, or more strains of bacteria. Generally, a population of bacterial spores contains a majority of spores and a minority of vegetative cells. In some examples, a population of bacterial spores does not contain vegetative cells. In some examples, a population of bacterial spores may contain less than about 1%, 2%, 3%, 4%, 5%, 6%, 7%, 8%, 9%, 10%, 15%, 20%, 25%, 30%, 40%, or 50% vegetative cells, where the percentage of bacterial spores is calculated as ((vegetative cells/ (spores in population + vegetative cells in population)) × 100). Generally, populations of bacterial spores used in the disclosed methods, compositions and products are stable (i.e. not undergoing germination), with at least some individual spores in the population capable of germinating.

Populations of bacterial spores used in this disclosure may contain bacterial spores at different concentrations. In various examples, populations of bacterial spores may contain, without limitation, at least 1×10², 5×10², 1×10³, 5×10³, 1×10⁴, 5×10⁴, 1×10⁵, 5×10⁵, 1×10⁶, 5×10⁶, 1×10⁷, 5×10⁷, 1×10⁸, 5×10⁸, 1×10⁹, 5×10⁹, 1×10¹⁰, 5×10¹⁰, 1×10¹¹, 5×10¹¹, 1×10¹², 5×10¹², 1×10¹³, 5×10¹³, 1×10¹⁴, or 5×10¹⁴ spores/ml, spores/gram, or spores/cm³.

The dryer sheet disclosed herein can be conveniently employed to treat fabrics during a drying process in a dryer. The dryer sheet can be used to treat fabrics that have not been washed or after the fabrics have been washed with a laundry detergent.

### Dryer Sheet

The dryer sheet of the invention comprises a substrate, a fabric treatment composition and from about 1×10² to about 1×10⁹ CFU/g of dryer sheet of cleaning microorganisms, preferably from about 1×10³ to about 1 ×10⁶ CFU/g of dryer sheet of cleaning microorganisms. Preferably, the cleaning microorganisms comprise bacterial spores, preferably Bacillaceae spores, more preferably Bacillus spores, more preferably Bacillus spores selected from the group consisting of Bacillus subtilis, Bacillus amyloliquefaciens, Bacillus licheniformis, Bacillus megaterium, Bacillus pumilus and mixtures thereof.

Dryer sheets can be prepared by soaking an absorbent flexible substrate with a liquid mixture of a fabric treatment composition, pressing the resultant soaked sheet to remove any excess liquid and then drying the sheet. Dryer sheets known in the art are preferably prepared by coating an absorbent flexible substrate with a molten mixture of the fabric treating composition and then solidifying the mixture. The fabric treatment composition transfers to the fabric during a drying operation to impart the cleaning microorganisms and fabric conditioning properties to the fabric. At an activation temperature that is achieved during a drying cycle in a dryer, at least a portion of the fabric treatment composition transfers from the substrate to the fabric to impart fabric conditioning properties and the cleaning microorganisms to the fabric. The activation temperature refers to the temperature at which the fabric treatment composition transfers to the laundry.

The dryer sheet can be provided from components that are considered biodegradable or compostable. The terms biodegradable or compostable, are meant to refer to the ability of the dryer sheet to undergo degradation via biodegradation or hydrolysis under conditions favorable to biodegradation or hydrolysis (e.g., composting environment at 95% relative humidity and 180° F.) so that at least 95% of the components are considered degraded within a time period of about 90 days. The dryer sheet can be manufactured from only materials that are considered biodegradable or compostable, or the dryer sheet can be manufactured from a combination of materials that are considered biodegradable or compostable and materials that do not satisfy the biodegradable or compostable test. In addition, the dryer sheet can be provided so that it is characterized as biodegradable under ASTM D 6868-03. Although ASTM D 6868-03 refers to the definition of biodegradability for plastics used as coatings on paper, this definition can be used for determining the biodegradability of paper products.

The dryer sheet preferably comprises a fibrous substrate, it can be a woven or nonwoven substrate. The substrate can be a single layer substrate or dual-layer substrate. A dual-layer substrate comprises a fibrous first layer, the first layer having a first layer interior surface and a first layer exterior surface opposing the first layer interior surface, wherein the first layer exterior surface has a first layer exterior surface area; a nonwoven fibrous second layer joined to the first layer, the second layer having a second layer interior surface and a second layer exterior surface opposing the second layer interior surface, wherein the second layer exterior surface has a second layer exterior surface area, wherein the second layer interior surface is oriented towards the first layer interior surface. The dryer sheet comprises cleaning microorganism, preferably bacterial spores. The cleaning microorganisms can be part of the fabric treatment composition. In a dual layer-substrate part of the fabric treatment composition is preferably on the first layer interior surface and partially penetrating into the first layer; wherein the first layer exterior surface is free from the fabric treatment composition over more than about 60% of the first layer exterior surface; wherein the second layer exterior surface is free from the fabric treatment composition over more than about 60% of the second layer exterior surface. Preferably the fabric treatment composition is present at a weight ratio relative to the first layer and the second layer combined from about 10:1 to about 1000:1.

### Nonwoven Fibrous Materials

Nonwoven fibrous materials provide for adequate function as a carrier for the cleaning microorganism and fabric treatment composition. The nonwoven fibrous material can be a polyester nonwoven fibrous material. For example, the nonwoven fibrous material can be polyester terephthalate. The nonwoven fibrous material can be a spun bonded polyester terephthalate. Optionally, the nonwoven fibrous material can be continuous filament spun bonded polyester terephthalate. Other nonwoven fibrous materials, such as rayon, can also be practical.

The nonwoven fibrous material can have a basis weight from about 10 g/m² to about 50 g/m². Such fibrous materials have sufficient constitution to carry the desired quantity of bacterial composition.

To provide for the desired release of the bacterial composition, the nonwoven fibrous material can have a permeability of from about 50 Darcys to about 150 Darcys, optionally about 90 Darcys to about 140 Darcys. The fibers constituting the nonwoven fibrous material can have a denier from about 2 to about 6. The nonwoven fibrous material can have a caliper from about 0.1 mm to about 0.5 mm, or optionally from about 0.1 mm to about 0.4 mm. The greater the caliper, the more space within the nonwoven fibrous material to hold a fabric treatment composition.

The nonwoven substrate can comprise natural fiber and regenerated cellulose fiber. The substrate can include a sufficient amount of regenerated cellulose fiber to provide the nonwoven substrate with desired cloth or hand feel characteristics, and to provide the nonwoven substrate with desired porosity.

Natural fiber refers to fiber formed from plants or animals. Natural fibers are not fibers that are formed as a result of extrusion or spinning. The natural fibers can be obtained from a source of fiber using techniques such as chemical pulping, chemical mechanical pulping, semi chemical pulping, or mechanical pulping. Natural fibers from plants are often referred to as cellulosic fibers.

Exemplary natural fibers that can be used to form the nonwoven substrate include wood fibers and non-wood natural fibers such as vegetable fibers, cotton, various straws (e.g., wheat, rye, and others), various canes (e.g., bagasse and kenaf), silk, animal fiber (e.g., wool), grasses (e.g., bamboo, etc.), hemp, corn stalks, abaca, etc.

Wood fiber can be obtained from wood pulp. The wood pulp can include hardwood fibers, softwood fibers, or a blend of hardwood fibers and softwood fibers. The pulp can be provided as cellulose fiber from chemical pulped wood, and can include a blend from coniferous and deciduous trees. By way of example, wood fibers can be from northern hardwood, northern softwood, southern hardwood, or southern softwood. Hardwood fibers tend to be more brittle but are generally more cost effective for use because the yield of pulp from hardwood is higher than the yield of pulp from softwood. The pulp can contain about 0 to about 100% or about 0 to about 70% hardwood fibers based on the weight of the fibers. Softwood fibers have desired paper making characteristics but are generally more expensive than hardwood fibers. The pulp can contain about 0 to about 100% softwood fibers based on the weight of the fibers. The pulp can contain a blend of hardwood and softwood fibers.

The natural fibers can be extracted with various pulping techniques. For example, mechanical or high yield pulping can be used for stone ground wood, pressurized ground wood, refiner mechanical pulp, and thermomechanical pulp. Chemical pulping can be used incorporating kraft, sulfite, and soda processing. Semi-chemical and chemi-mechanical pulping can also be used which includes combinations of mechanical and chemical processes to produce chemi-thermomechanical pulp.

The natural fibers can also be bleached or unbleached. One of skill in the art will appreciate that the bleaching can be accomplished through many methods including the use of chlorine, hypochlorite, chlorine dioxide, oxygen, peroxide, ozone, or a caustic extraction.

The pulp can include a recycle source for reclaimed fiber. Exemplary recycle sources include post-consumer waste (PCW) fiber, office waste, and corrugated carton waste. Post-consumer waste fiber refers to fiber recovered from paper that is recycled after consumer use. Office waste refers to fiber obtained from office waste, and corrugated carton waste refers to fiber obtained from corrugated cartons. Additional sources of reclaimed fiber include newsprint and magazines. Reclaimed fiber can include both natural and synthetic fiber. Incorporation of reclaimed fiber in the nonwoven substrate can aid in efficient use of resources and increase satisfaction of the end user of the dryer sheet.

Refining is the treatment of pulp fibers to develop their papermaking properties. Refining increases the strength of fiber to fiber bonds by increasing the surface area of the fibers and making the fibers more pliable to conform around each other, which increases the bonding surface area and leads to a denser sheet, with fewer voids. Most strength properties of paper increase with pulp refining, since they rely on fiber to fiber bonding. The tear strength, which depends highly on the strength of the individual fibers, has a tendency to decrease with refining. Refining of pulp increases the fibers flexibility and leads to a denser substrate. This means bulk, opacity, and porosity decrease (densometer values increase) with refining. Fibrillation is a result of refining paper fibers. Fibrillation is the production of rough surfaces on fibers by mechanical and/or chemical action; refiners break the outer layer of fibers, e.g., the primary cell wall, causing the fibrils from the secondary cell wall to protrude from the fiber surfaces.

The fibers can be refined so that the resulting nonwoven substrate provides the desired Canadian Standard Freeness value. In general, less refined fiber can provide a nonwoven substrate having more holes and voids and thereby permitting greater penetration into the nonwoven substrate. It may be desirable to provide a desired level of refining to control the presence of holes or voids so that the nonwoven substrate can contain a desired amount or loading of the fabric conditioning agent.

The nonwoven substrate can comprise natural fiber and regenerated cellulose fiber. The substrate can include a sufficient amount of regenerated cellulose fiber to provide the nonwoven substrate with desired cloth or hand feel characteristics, and to provide the nonwoven substrate with desired porosity.

Regenerated cellulose fiber can be considered a type of fiber prepared from cellulose and wherein the fiber is formed as a result of extrusion or spinning. An exemplary regenerated cellulose fiber can be referred to as rayon or as viscose. It is understood that viscose is generally another term for rayon.

The nonwoven substrate can contain a sufficient amount of the regenerated cellulose fiber so that the dryer sheet exhibits desirable cloth and hand feel characteristics. In general, the cloth or hand feel characteristics of the dryer sheet can be provided so that they are similar to the cloth or hand feel characteristics of commercial dryer sheet products such as those available under the names Bounce® and Downy® from The Procter & Gamble Company. The natural fiber can provide a nonwoven substrate for use as a dryer sheet that is relatively inexpensive, but has a tendency to provide the dryer sheet with stiffness. Regenerated cellulose fiber can be included in the nonwoven substrate in an amount sufficient to improve the cloth and hand feel characteristics of the nonwoven substrate.

The nonwoven substrate can contain a sufficient amount of the regenerated cellulose fiber so that the resulting nonwoven substrate has a desired level of porosity or air permeability. In general, providing the nonwoven substrate with a desired level of air permeability allows the nonwoven substrate to handle or contain a desired amount or loading of fabric conditioning agent. The air permeability of the nonwoven substrate can be controlled to allow for sufficient loading of the fabric conditioning agent onto the nonwoven substrate. It can be desirable for the nonwoven substrate to have an air permeability of at least 6 CFM (cubic feet per minute per ft2) according to Tappi T 251CM-85.

The nonwoven substrate can be prepared from fibers containing natural fiber, regenerated cellulose fiber, or a mixture of natural fiber and regenerated cellulose fiber. The nonwoven substrate can contain 0 wt. % to 100 wt. % natural fiber and can contain 0 wt. % to 100 wt. % regenerated cellulose fiber, based on the weight of the fiber of the nonwoven substrate. In order to provide the nonwoven substrate with desired cloth and hand feel properties or to provide the nonwoven substrate with desired air permeability, the nonwoven substrate can be prepared from a mixture of natural fiber and regenerated cellulose fiber. The nonwoven substrate can be prepared from a mixture containing about 10 wt. % to about 95 wt. % natural fiber, about 20 wt. % to about 92 wt. % natural fiber, about 40 wt. % to about 90 wt. % natural fiber, or about 50 wt. % to about 85 wt. % natural fiber. The nonwoven substrate can be prepared from a mixture containing about 0.5 wt. % to about 75 wt. % regenerated cellulose fiber, about 2 wt. % to about 60 wt. % regenerated cellulose fiber, about 10 wt. % to about 55 wt. % regenerated cellulose fiber, or about 20 wt. % to about 50 wt. % regenerated cellulose fiber. The weight percent of fiber is based upon the fiber content of the nonwoven substrate.

It can be desirable to provide the regenerated cellulose fiber having a length that is as long as possible to form a nonwoven substrate on a paper making machine in order to obtain the maximum benefit of the presence of the regenerated cellulose fiber. In general, it is expected that by using a longer regenerated cellulose fiber, it may be possible to use less of the regenerated cellulose fiber prepared with a nonwoven substrate that uses shorter fiber. In general, an exemplary regenerated cellulose fiber length that can be used on a paper making machine is about 3 mm to about 6 mm (about ⅛ inch to about ¼ inch). It may be desirable to provide the regenerated cellulose fiber having a length of up to about 2 inches.

The regenerated cellulose fiber can have a denier selected to provide desired cloth or hand feel characteristics. In general, a small denier can be used to enhance the cloth or hand feel characteristics. Fibers having a larger denier tend to be more coarse. Accordingly, the regenerated cellulose fiber can have a denier of about 0.5 to about 20, a denier of about 0.5 to about 10, a denier of about 0.5 to about 5, or a denier of about 1.0 to about 2.

The nonwoven fibrous material can be a continuous filament of polyester homopolymer and binder filaments formed of a polyester copolymer. The nonwoven fibrous material can be a polyolefin nonwoven. The nonwoven fibrous material can be spunbonded nonwoven. The nonwoven fibrous material can be an area bonded or point bonded nonwoven. The nonwoven fibrous material can be a spun bonded polyethylene terephthalate having trilobal fibers having a denier from about 5 to about 6. The nonwoven fibrous material can be a spun bonded a bicomponent fiber having a polyethylene terephthalate core and copolyethylene terephthalate with isophthatlate and or mixture thereof.

The nonwoven fibrous material can comprise bicomponent fibers. The bicomponent fibers can be core-sheath constructions or lobed constructions. The nonwoven fibrous material can comprise bicomponent fibers that are polyethylene/polyethylene terephthalate core-sheath constructions, with either constituent forming the core or sheath. The bicomponent fibers can be polyethylene/polypropylene, with either constituent forming the core or sheath.

The nonwoven fibrous material can be the nonwoven fibrous material used presently or in the past or like that used presently or in the past in BOUNCE dryer sheets, available from The Procter & Gamble Company, Cincinnati, OH, United States of America, SNUGGLE dryer sheets, available from Henkel Corporation, Stamford, Connecticut, United States of America, and or SUAVITEL dryer sheets, available from Colgate-Palmolive Company, New York, New Yok, United States of America.

The nonwoven fibrous material can be cellulose.

### Process of Manufacture

The dryer sheet can be practically formed using a continuous web converting process. A nonwoven fibrous web can be provided. The nonwoven fibrous web can have a top surface and an opposing bottom surface and a pair of web transverse edges. A fabric treatment composition preferably comprising the cleaning microorganisms, can be applied to the top surface. The nonwoven fibrous web can be folded toward the top surface about a fold line that divides the first layer and the second layer to bring the web transverse edges into alignment with one another so that the second layer is above the first layer. The nonwoven fibrous web can be cut to form the dryer sheet. The nonwoven fibrous web can practically be cut before it is folded or after it is folded but may be simpler to convert if the nonwoven fibrous web is cut after being folded.

The cleaning microorganisms, preferably as part of a fabric treatment composition, can be applied to the top surface by slot coating, spray coating, kiss rolling, printing, rotogravure, and other processes for applying the cleaning microorganisms as a liquid. One practical approach for applying the fabric treatment composition to a nonwoven fibrous material, as the nonwoven fibrous layers are employed herein, is to slot coat the nonwoven fibrous material and use a scraper set at or just above the surface to which the composition is applied to scrape off the composition at some level at or above the surface of the nonwoven fibrous material so that excess composition is removed.

The cleaning microorganisms, preferably as part of a fabric treatment composition, may partially penetrate into the nonwoven fibrous web. The cleaning microorganisms, preferably as part of a fabric treatment composition, may be applied to one of what becomes the first layer interior surface and or the second layer interior surface. The step of folding can be conveniently accomplished with a folding rail. Other folding process may be employed if the nonwoven fibrous web is cut in the cross direction CD prior to folding or individual pieces of nonwoven fibrous web are provided and then each dryer sheet is folded individually.

Once the nonwoven fibrous web, or an individual piece of nonwoven fibrous web, is folded over on itself, the web transverse edges can be bonded to one another. The step of bonding can be performed before or after the step of cutting in the cross direction CD. The bonding can provide coherency to the dryer sheet as described previously.

Once the first layer and second layer, or the pieces or parts of nonwoven fibrous web that ultimately become the first layer and second layer, are positioned as desired, the layers can be embossed to provide embossments to the layers and to squeeze the fabric treatment composition, within the layers so that the fabric treatment composition fully penetrates the layers. Embossing can be accomplished by an embossing roll such as a cylindrical roll having raised embossing features of the desired pattern that is in operative relationship with an anvil roll.

Another approach for forming the dryer sheet is to provide the first layer and the second layer. The first layer and the second layer can be provided integral with one another as a single nonwoven fibrous web moving in the machine direction MD. The cleaning microorganisms, preferably as part of a fabric treatment composition, can be applied to the first layer interior surface and or the second layer interior surface, if the first layer and second layer are provided as individual lanes, or the nonwoven fibrous web can be cut in the machine direction MD after the fabric treatment composition is applied to form lanes of the material that ultimately becomes the first layer and second layer.

One of the first layer and the second layer can be flipped. Flipping can position the surface of the layers to which the bacterial composition is applied to be oriented towards one another when the first layer is stacked onto the second layer. Flipping can be performed before or after the nonwoven fibrous web is cut in the cross direction CD.

Once one of the layers is flipped, the first layer and the second layer can be stacked so that the first layer interior surface is oriented towards the second layer interior surface. The first layer can be bonded to the second layer, which provides the benefit of helping to maintain the form of the dryer sheet before, during, and after use.

### Fabric Treatment Composition

The dryer sheet comprises a fabric treatment composition, the fabric treatment composition can provide care, fragrance, antiwrinkle, color protection, antistatic, softening benefits and any other benefits that add to the longevity and good feeling of fabrics. The cleaning microorganisms can be part of the fabric treatment composition. The fabric treatment composition can be a fabric softening composition such as any of the fabric softening compositions used presently or in the past or like that used presently or in the past in BOUNCE dryer sheets, available from The Procter & Gamble Company, Cincinnati, OH, United States of America, SNUGGLE dryer sheets, available from Henkel Corporation, Stamford, Connecticut, United States of America, and or SUAVITEL dryer sheets, available from Colgate-Palmolive Company, New York, New Yok, United States of America

The fabric treatment composition is preferably a fabric softening composition. The fabric softening composition preferably comprises from about 10% to about 90% by weight of the composition of a softening agent, preferably a quaternary ammonium compound. The quaternary ammonium compound may be ester and or amide linked.

The fabric softening composition may comprise a cationic nitrogen-containing compound such as a quaternary ammonium compound having one or two straight-chain organic groups of at least 8 carbon atoms; optionally one or two such groups of from 12 to 22 carbon atoms and, optionally be ester and or amide linked. Specific non-limiting examples of fabric softening actives include the following: Di Tallow, Di Methyl Ammonium Methyl Sulfate, N,N-di(oleyi-oxy-ethyl)-N,N-dimethyl ammonium chloride, N,N-di(canolyl-oxy-ethyl)-N,N-dimethyl ammonium chloride, N,N-di(oleyl-oxy-ethyl)-N-methyl, N-(2-hydroxyethyl) ammonium methyl sulfate, N,N-di(canolyl-oxy-ethyl)-N-methyl, N-(2-hydroxyethyl) ammonium methyl sulfate-, N,N-di(oleylamidoethyl)-N-methyl, N-(2-hydroxyethyl) ammonium methyl sulfate, N,N-di(2-oleyloxy oxo-ethyl)-N,N-dimethyl ammonium chloride, N,N-di(2-canolyloxy oxo-ethyl)-N,N-dimethyl ammonium chloride-, N,N-di(2-oleyloxyethylcarbonyloxyethyl)-N,N-dimethyl ammonium chloride, N,N-di(2-canolyloxyethylcarbonyloxyethyl)-N,N-dimethyl ammonium chloride, N-(2-oleyloxy ethyl)-N-(2-oleyloxy oxo-ethyl)-N,N-dimethyl ammonium chloride; N-(2-canolyloxy ethyl)-N-(2-canolyloxy oxo-ethyl)-N,N-dimethyl ammonium chloride, N,N,N-tri(oleyl-oxyethyl)-N-methyl ammonium chloride, N,N,N-tri(canolyi-oxy-ethyl)-N-methyl ammonium chloride-, N-(2-oleyloxy oxoethyl)-N-(oleyl)-N,N-dimethyl ammonium chloride, N-(2-canolyloxy oxoethyl)-N-(canolyl)-N,N-dimethyl ammonium chloride, 1,2-dioleyloxy N,N,N-trimethylammoniopropane chloride, and 5,2-dicanolyloxy N,N,N-trimethylammoniopropane chloride, and combinations thereof. In one embodiment, the fabric conditioning active is N,N-di(tallowyl-oxy-ethyl)-N-methyl, N-(2-hydroxyethyl) ammonium methyl sulfate.

The fabric softening composition may comprise ingredients such as a nonionic material. Suitable nonionic materials may include polyoxyalkylene glycols, higher fatty alcohol esters of polyoxyalkylene glycols, higher fatty alcohol esters of polyoxyalkylene glycols, ethoxylates of long chained alcohols of from 8 to 30 carbon atoms such as the ethoxylates of coconut, palm, tallow alcohols or hydrogenated alcohols with 4 to 40 moles of ethylene oxide, and alkanolamides. The fabric softening composition may further comprise, with or without a non-ionic material, fatty acids, ethoxylated fatty acids, and combinations thereof. Suitable fatty acids include those wherein the long chain is unsubstituted or substituted alkyl or alkenyl group of from about 8 to 30 carbon atoms. Examples of specific fatty acids are lauric, palmitic, stearic, oleic, and/or combinations thereof.

The fabric softening composition may comprise one or more organic compounds having at least one relatively long hydrocarbon group serving to provide lubricity and or antistatic effects. Among such groups are alkyl groups containing 8 or more carbon atoms or even 12 to 22 carbon atoms. Suitable fabric softening compositions may comprise cationic, anionic, nonionic, or zwitterionic compounds. Cationic nitrogen containing compounds such as quaternary ammonium compounds having one or two straight chain organic groups of at least eight carbon atoms are practical.

The fabric softening composition can contain less than about 5% by weight of fatty acid. The fabric softening composition can be selected from the group consisting of polyglyceryl distearate, parrafin wax, branched parrafin wax, polyglyceryl ethers, and combinations thereof. Suitable fabric softening compositions include cationic, anionic, nonionic, or zwitterionic compounds. The fabric softening composition can be a quaternary imidazolinium salt. Optionally, the fabric softening composition can be a polyoxyalkylene glycol, including higher fatty alcohol esters of polyoxyalkylene glycol and higher fatty alcohol ethers of polyoxyalkylene glycol. The fabric softening composition can be a fatty acid ester of sorbitan and ethoxylates of such esters.

### Other Fabric Treatment Ingredients

The fabric treatment composition can comprise a variety of ingredients. The fabric treatment composition may comprise unencapsulated perfume, encapsulated perfume, and combinations thereof. The encapsulated perfume, if provided, can be selected from the group consisting of friable encapsulates, moisture activated encapsulates, heat activated encapsulates and combinations thereof.

The fabric softening composition can comprise ingredients selected from the group consisting of softening agents, soil release agents, anti-static agents, crisping agents, water/stain repellents, stain release agents, refreshing agents, disinfecting agents, wrinkle resistant agents, wrinkle release agents, odor resistance agents, malodor control agents, abrasion resistance and protection agents, solvents, insect/pet repellents, wetting agents, chlorine scavenging agents, optical brighteners, UV protection agents, skin/fabric conditioning agents, skin/fabric nurturing agents, skin/fabric hydrating agents, color protection agents, dye fixatives, dye transfer inhibiting agents, silicones, preservatives and anti-microbials, fungicides, fabric shrinkage-reducing agents, brighteners, hueing dyes, bleaches, chelants, antifoams, anti-scum agents, whitening agents, catalysts, cyclodextrin, zeolite, petrolatum, glycerin, triglycerides, vitamins, other skin care actives such as aloe vera, chamomile, shea butter and the like, mineral oils, and combinations thereof.

### Perfume

In addition to the fabric treatment composition, the dryer sheet can further comprise 0.1% to about 20% by weight perfume. The perfume can be unencapsulated perfume, encapsulated perfume, perfume provided by a perfume delivery technology, or a perfume provided in some other manner. Perfumes are generally described in U.S. Pat. No. 7,186,680 at column 10, line 56, to column 25, line 22. The dryer sheet can comprise unencapsulated perfume and are essentially free of perfume carriers, such as a perfume microcapsules. The dryer sheet can comprise perfume carrier materials (and perfume contained therein). Examples of perfume carrier materials are described in U.S. Pat. No. 7,186,680, column 25, line 23, to column 31, line 7. Specific examples of perfume carrier materials may include cyclodextrin and zeolites.

The dryer sheet can comprise about 0.1% to about 20%, alternatively about 1% to about 15%, alternatively 2% to about 10%, alternatively combinations thereof and any whole percentages within any of the aforementioned ranges, of perfume by weight of the dryer sheet. The dryer sheet can comprise from about 0.1% by weight to about 6% by weight of the dryer sheet of perfume. The perfume can be unencapsulated perfume and or encapsulated perfume.

The dryer sheet can be free or substantially free of a perfume carrier. The dryer sheet may comprise about 0.1% to about 20%, alternatively about 1% to about 15%, alternatively 2% to about 10%, alternatively combinations thereof and any whole percentages within any dryer sheet.

The dryer sheet can comprise unencapsulated perfume and perfume microcapsules. The dryer sheet may comprise about 0.1% to about 20%, alternatively about 1% to about 15%, alternatively from about 2% to about 10%, alternatively combinations thereof and any whole percentages or ranges of whole percentages within any of the aforementioned ranges, of the unencapsulated perfume by weight of the dryer sheet. Such levels of unencapsulated perfume can be appropriate for any of the dryer sheet disclosed herein that have unencapsulated perfume.

The dryer sheet can comprise unencapsulated perfume and a perfume microcapsule but be free or essentially free of other perfume carriers. The dryer sheet can comprise unencapsulated perfume and perfume microcapsules and be free of other perfume carriers.

The dryer sheet can comprise encapsulated perfume. Encapsulated perfume can be provided as plurality of perfume microcapsules. A perfume microcapsule is perfume oil enclosed within a shell. The shell can have an average shell thickness less than the maximum dimension of the perfume core. The perfume microcapsules can be friable perfume microcapsules. The perfume microcapsules can be moisture activated perfume microcapsules.

The perfume microcapsules can comprise a melamine/formaldehyde shell. Perfume microcapsules may be obtained from Appleton, Quest International, or International Flavor & Fragrances, or other suitable source. The perfume microcapsule shell can be coated with polymer to enhance the ability of the perfume microcapsule to adhere to fabric. This can be desirable if the particles are designed to be a fabric treatment composition. The perfume microcapsules can be those described in U.S. Pat. Pub. 2008/0305982.

The dryer sheet can comprise about 0.1% to about 20%, alternatively about 0.1% to about 10%, alternatively about 1% to about 15%, alternatively 2% to about 10%, alternatively combinations thereof and any whole percentages within any of the aforementioned ranges, of encapsulated perfume by weight of the dryer sheet.

The dryer sheet can comprise perfume microcapsules but be free of or essentially free of unencapsulated perfume. The particles may comprise about 0.1% to about 20%, alternatively about 1% to about 15%, alternatively about 2% to about 10%, alternatively combinations thereof and any whole percentages within any of the aforementioned ranges, of encapsulated perfume by weight of the dryer sheet.

### Methods

### Analysis of Microorganism From Dryer Sheets

Extraction of microorganisms: the extraction of cleaning microorganism from a dryer fabric sheet containing spores (SDFS) can be carried out in methanol (HPLC grade ≥ 99.9%) as follows. A SDFS measuring 6.4-inch × 9-inch (l′ × w″) containing 0.01% w/w of spore is cut into four equal quarters using sterile scissors and placed in aluminum foil until needed for use. One of the four quarters of the SDFS is then further cut into smaller pieces (less than 1 cm × 1 cm each) with sterile scissors and placed in a 4-oz glass jar with 10 ml of methanol added to completely submerge the SDFS pieces. The glass jar is swirled by hand for about 5 seconds after all 10 ml of methanol is added to make a source stock solution and this solution is assigned dilution 100. The same extraction process is repeated with the other three quarters of the sheet to create four source stock solutions each assigned 100 dilution.

Serial Dilutions: each source stock solution is swirled by hand for 5 seconds before 1 ml is aseptically drawn from the 4-oz glass jar and transferred into a test tube containing 9 ml of 0.85% saline solution to achieve 10-fold dilution and then vortexed for 30 seconds to mix. The first dilution tube is assigned dilution 10⁻¹ or ⅒. The serial dilution is repeated with the next tube by aseptically transferring 1 ml from previous dilution to 9 ml 0.85% saline solution, vortexed in between dilutions until 10⁻¹ to 10⁻¹⁰ dilution factors are achieved. The process is repeated with the other three sources stock solutions.

Plating: the spread plate method can be used to quantify the amount of cleaning microorganisms. Aseptically, 1 ml from each dilution 10⁻¹ to 10⁻¹⁰ is drawn and plated onto appropriately labeled agar culture plate. The agar culture plate contains the necessary medium that promote the growth of cleaning microorganism such as tryptic soy agar (TSA, G60BX Hardy Diagnostics) for general purpose non-selective agar or nutrient yeast salt medium (NYSM, 470180-702 (VWR)) for selective growth of organisms such as bacillus cleaning microorganisms. The spread plates are inverted with the lid on and placed into an incubator (Model: Heratherm IMH60-S, SN: 41927867) at 37° C. for 16-24 hours or appropriate time of incubation that support the microorganism growth and proliferation of colonies. After an appropriate time, each agar culture plate is examined without opening it to look for individual colonies. Plates that had countable colonies (30-300 individual colonies) are counted and the colony forming units (CFUs) are recorded, corresponding to their dilution factors. The microorganism (CFU) per milliliter or gram of sample from each four equal quarters is calculated by dividing the number of colonies by the corresponding dilution factor using this formula:

$$\begin{matrix}\text{CFU} / \text{ml} = \left(\text{no} \text{. of countable colonies x dilution factor}\right) / \\ \left(\text{volume} \left(\text{ml}\right) \text{of the culture plate}\right)\end{matrix} \qquad \text{Formula 1:}$$

To reflect the precision of the plating method, the CFU/ml is reported to include not more than two significant figures.

The CFU/ml in Formula 1 correspond to CFU per quarter of the dryer sheet. The total CFU in the entire dryer sheet is calculated by summing up all the CFUs from each quarter using this formula:

$$\begin{matrix}\text{Total CFU per dryer sheet = CFU} \left(1 \text{st quarter+2nd quarter+}\right) \\ \left(\text{3rd quarter+4th quarter}\right)\end{matrix} \qquad \text{Formula 2:}$$

To calculate the CFU per weight of the dryer sheet, the following formula is used:

$$\begin{matrix}\text{CFU per gram of dryer sheet =} \left(\text{Total CFU per sheet}\right) / \left(\text{Dryer}\right) \\ \left(\text{sheet weight in grams}\right) .\end{matrix} \qquad \text{Formula 3:}$$

### EXAMPLES

### Example 1: Making Spore Infused Fabric Treatment Composition (Sp-i-FTC)

A fabric treatment composition (FTC) comprising Di(tallow oxyethyl) hydroxyethyl methyl ammonium methyl sulfate and perfume oil mixtures was used to prepare a fabric treatment composition comprising spores (Table 1) by weighing 99.99 g of the fabric treatment composition in a glass jar and allowing it to melt overnight at 70° C. in an oven. The glass jar of melted fabric treatment composition was place in a water bath (VWR 10L, Model number: 97025-134) set at 70° C. About 2L VWR Glass Beaker with 500 ml DI water was heated to 70° C. on a hotplate (Cole-Parmer hotplate model number: 03407-10)) to maintain the temperature of the molten fabric treatment composition throughout the process.

To infuse the spore powder, the pre-weighed base fabric treatment composition in the glass jar was placed on a hotplate set at 70° C. Using an overhead stirrer (IKA RW20, model number: RW 20DS1) equipped with an impeller blade, the fabric treatment composition was mixed thoroughly at 360 rpm to create a small vortex during mixing and homogeneous fabric treatment composition melt. While mixing, 0.01 g of Bacillus spore powder (7.02 × 10² CFU/g) that was accurately pre-weighed was added to the FTC. The mixing was continued for at least 5 minutes after the last amount of 0.01 g Bacillus spore powder mix was added to ensure full incorporation and achieve completely homogenous spore infused fabric treatment composition (Sp-i-FTC). If the molten Sp-i-FTC was not used immediately, it was poured onto a sheet of aluminum foil and allowed to cool down completely. The Sp-i-FTC was further inspected for any potential inhomogeneity or other indication that Bacillus spore powder mix was not fully dispersed. Once the Sp-i-FTC was cooled down, it was broken into small chunks by hand and stored in a glass jar until needed for use. The procedure was repeated for fabric treatment composition 2 as the control with nil Bacillus spores powder as shown in Table 1.

TABLE 1

| | Ingredients | Activity | FP Active (% wt.) | Target (wt. g) | CFUs/100g of spore infused fabric treatment composition (Sp-i-FTC) |
|---|---|---|---|---|---|
| Fabric treatment composition 1 | Fabric treatment composition (FTC) | 100 | 99.99 | 99.99 | 7.02 ×10^{8∗∗} |
| | Bacillus Spores powder (Sp) | 100 | 00.01 | 00.01 | |
| Fabric treatment | Fabric treatment composition (FTC) | 100 | 100.0 | 100.00 | 0.00 |
| composition 2 (Control) | Bacillus Spores powder (Sp) | 100 | 00.00 | 00.00 | |

^{∗∗}Theoretical/calculated Colony Forming Units (per gram CFUs/g)

### Example 2: Dryer Fabric Sheet Making With Spore Infused Fabric Treatment Composition (FTC)

A 6.4″ × 9″ dryer sheet (Non-woven substrate) was placed on a balance (Mettler Toledo, model number: PG503-5) and tare its weight 0.65±0.01 g on the balance to zero and either of the application procedure was followed (Composition 1, Table 2):

(A) For liquid FTC: Molten Sp-i-FTC was used within 30 min to 1 hour of making. The Sp-i- FTC molten state was maintained by keeping it in water bath (VWR 10L, Model number: 97025-134) at 70° C. during the process. A pipette was used to deliver 1.5 g onto the dryer sheet placed on a custom-made aluminum cover plate for the water bath and spread evenly with metal spatula to cover the entire dryer sheet area. The coated dryer sheet should weigh 1.50±0.05 g on a balance tared to zero with dryer sheet prior to coating with Sp-i- FTC.

(B) For solid FTC: About 1.50 g of Sp-i- FTC was accurately weighed and transferred onto custom-made aluminum cover plate equilibrated to 80° C. by covering the water bath (VWR 10L, Model number: 97025-134) with the aluminum cover plate. The Sp-i- FTC was spread around the flat metal cover until it melted evenly on marked area equal to the size of the dryer sheet. The dryer sheet was placed on melted Sp-i-FTC to absorb the molten Sp-i-FTC into the dryer sheet. The dryer sheet was flipped over to absorb SP-i-FTC into the opposite side for complete coating. The coated dryer sheet weight was periodically monitored until the desired SP-i-FTC amount was absorbed into the dryer sheet. The procedure was repeated by adding more SP-i-FTC, if needed until the dryer sheet was coated with 1.50+0.05 g of SP-i-FTC determined by weighing on the balance tared to zero with dryer sheet prior to coating process. Any excess SP-i-FTC to the target amount was removed by placing the coated dryer sheet on the aluminum cover plate at 80° C. to melt off the excess amount to achieve the desired coated dryer sheet weight. The coated dryer sheets were wrapped and sealed with an aluminum foil and stored at ambient room temperature until needed for testing. The procedure A or B was repeated with the fabric treatment composition free of spores for control samples (Composition 2) while Composition 3 was the substrate only without both the fabric treatment composition and the spores.

TABLE 2

| | | | | | |
|---|---|---|---|---|---|
| | Ingredients | Added Wt (g) | Size in inches (l × w) | Target Wt (g) | Theoretical CFUs/spore Dryer sheet |
| Composition 1 | Spore infused Fabric treatment composition (Sp-i-FTC) | 1.50 | - | 1.50±0.05 | 1.05 × 10⁶ |
| | Dryer sheet (Non-woven substrate) | *Tare wt. | 6.4”×9” | - | |
| Composition 2 | Fabric treatment composition | 1.50 | - | 1.50±0.05 | 0.00 |
| | Dryer sheet (Non-woven substate) | *Tare wt. | 6.4”×9” | - | |
| Composition 3 | Dryer sheet (Non-woven substrate | 0.00 | 6.4”×9” | 0.65±0.01 | 0.00 |
| | | *Tare wt. 0.65±0.01 g | | | |

### Test 1: Spore Viability Test on Finished Spore Dryer Fabric Sheet (SDFS)

The viability of the spores from spore dryer fabric sheet (SDFS) was confirmed with agar impression. About 2″ × 3″ of SDFS cut out from Composition 1 was cut and impressed on nutrient yeast salt medium (NYSM) agar. NYSM agar is a selective medium that promotes Bacillus strain growth. The impression was done by placing the 2″ × 3″ cut out at the center of the agar surface for 10 seconds contact time applying very gentle pressure that does not dent or break the agar surface. The 2″ × 3″ cut out was removed and the NYSM agar was incubated in Innova42 Aerobic Incubator at ambient air condition at 37° C. for overnight growth of transferred spores. The procedure was repeated with 2″ × 3″ cut outs from Composition 2 & 3. Colonies of Bacillus Sp were only observed for Composition 1.

### Test 2: Spores Viability and Transfer in Tumble Dryer

Spore transfer from spore dryer fabric sheet (SDFS, Composition 1) was demonstrated by dampening sterile Cotton Terry (6.4 × 9 inches) with water. The SDFS (Composition 1) with damp Cotton Terry were tumble dried for 60 min in MAYTAG commercial dryer setting for whites and colors; high heat with cool down. The control experiment was performed separately in a second dryer with the Composition 1 alone in absence of the Terry. After 60 min the impressions of the Composition 1 and Terry and the impressions of Composition 1 without Terry were made on HiChrome Bacillus agar medium. It was observed that the amount of spores remained on the SDFS that was dried in the absence of Terry was considerable higher than the amount of spores remained on the SDFS that was dried with Terry.

### Test 3: Malodor Reduction Test. Consumer Items With Intense Malodor

Towels with intense malodor were sourced from consumers and cut into quarter sections. The towels sections were dampened aseptically with sterile water at 7gpg. For each test, a quarter of the dampened towel and 2 SDFS were placed in a mesh laundry bag to increase contact during tumbling. After tumble drying for 60 min, the dried towel sections were placed into clean bags for olfactive assessment and ranked in order of malodor intensities at different times: within 1 h and after 24 h, 48 h, 72 h, and >96 h by 5 volunteer judges. The ranking was averaged to generate a 5-point scale compared to the initial intense malodor of untreated towel over time.

TABLE 3

| | 1 hr | 24 hr | 48 hr | 72 hr | >96 hr |
|---|---|---|---|---|---|
| Composition 1 | 1.50 | 1.50 | 1.20 | 1.20 | 1.20 |
| Composition 2 | 3.40 | 3.30 | 3.00 | 2.90 | 2.90 |
| Composition 3 | 5.00 | 5.00 | 4.80 | 4.80 | 4.80 |
| Untreated towel | 5.00 | 5.00 | 5.00 | 5.00 | 5.00 |

| Malodor Rank | Malodor descriptor | Malodor Rank | Malodor descriptor |
|---|---|---|---|
| 1 | No noticeable malodor | 4 | Medium to High malodor |
| 2 | Hardly noticeable malodor | 5 | High to Intense malodor |
| 3 | Slight to Medium malodor | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of treating a fabric in a dryer, the method comprising:
a) placing the fabric in the dryer; and
b) delivering at least about 1×10² CFU of cleaning microorganisms into the dryer.

2. A method according to claim 1 wherein the cleaning microorganisms comprise bacteria and said bacteria comprises Bacillus.

3. A method according to claim 1, wherein the cleaning microorganisms comprise bacteria selected from the group consisting of Bacillus subtilis, Bacillus amyloliquefaciens, Bacillus licheniformis, Bacillus megaterium, Bacillus pumilus, and mixtures thereof.

4. A method according to claim 1, wherein the cleaning microorganisms are in a vegetative state or in the form of spores.

5. A method according to claim 1, wherein the cleaning microorganisms comprise bacterial spores.

6. A method according to claim 1, wherein the cleaning microorganisms comprise bacterial spores and said bacterial spores comprise Bacillus spores.

7. A method according to claim 1, wherein the cleaning microorganisms are delivered into the dryer from a solid carrier.

8. A method according to claim 1, wherein the cleaning microorganisms are delivered into the dryer from a solid carrier and wherein said solid carrier is a dryer sheet or a solid pellet.

9. A dryer sheet comprising a substrate, a fabric treatment composition, and from about 1×10² to about 1×10⁹ CFU/g of dryer sheet of cleaning microorganisms.

10. A dryer sheet according to claim 9 comprising about 1×10³ to about 1×10⁶ CFU/g of dryer sheet of said cleaning microorganisms.

11. A dryer sheet according to claim 9, wherein the cleaning microorganisms comprise bacteria.

12. A dryer sheet according to claim 9, wherein the cleaning microorganisms comprise bacterial spores and said bacteria spores comprises Bacillus spores.

13. A dryer sheet according to claim 9, wherein the cleaning microorganisms comprise bacterial spores selected from the group consisting of Bacillus subtilis, Bacillus amyloliquefaciens, Bacillus licheniformis, Bacillus megaterium, Bacillus pumilus, and mixtures thereof.

14. A dryer sheet according to claim 9, wherein the substrate is non-woven.

15. A dryer sheet according to claim 9, wherein the substrate comprises a first layer comprising embossments and a second layer comprising embossments, through which the cleaning microorganisms penetrate said first layer and said second layer.

16. A dryer sheet according to claim 9, wherein the fabric treatment composition comprises a fabric softening composition and wherein the cleaning microorganisms comprises Bacillus spores.

17. A dryer sheet according to claim 9, wherein the fabric treatment composition comprises a fabric softening composition said fabric softening composition comprising a quaternary ammonium compound.

18. A process for forming a dryer sheet comprising a substrate, a fabric treatment composition and from about 1×10² to about 1×10⁹ CFU/g of dryer sheet of cleaning microorganisms, said process comprising:
providing a nonwoven fibrous web having a top surface and an opposing bottom surface and a pair of web transverse edges;
applying to the top surface cleaning microorganisms;
folding the nonwoven fibrous web toward the top surface about a fold line dividing the first layer and the second layer to bring the web transverse edges into alignment with one another so that the second layer is above said first layer;
bonding the web transverse edges to one another, and
cutting the nonwoven fibrous web to form the dryer sheet.

19. A process according to claim 18 wherein the cleaning microorganisms comprise Bacillus spores.

20. A process according to claim 19 further comprising embossing the first layer and the second layer so that the cleaning microorganisms fully penetrate the first layer and the second layer.
